(19) United States
(12) Patent Application Publication
(10) Pub. No.: US 2006/0039495 A1
(43) Pub. Date: Feb. 23, 2006

(54) Apparatus and method for space-time block coding for increasing coding gain

(75) Inventors: Chan-Byoung Chae, Seoul (KR); Sung-Ryul Yun, Suwon-si (KR); Hong-Sil Jeong, Seoul (KR); Won-Il Roh, Yongin-si (KR); Dong-Seek Park, Yongin-si (KR); Pan-Yuh Joo, Seoul (KR); Jeong-Tae Oh, Yongin-si (KR); Kyun-Byoung Ko, Hwasung-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/205,252

(22) Filed: Aug. 16, 2005

(30) Foreign Application Priority Data
Aug. 17, 2004 (KR) 2004-64900

(51) Int. Cl. H04K 1/10; H04L 1/02

(52) U.S. Cl. 375/267

(57) ABSTRACT

A space-time block coding apparatus and method in a transmitter with four transmit antennas in a system using a space-time block coding scheme, a pre-coder pre-codes an input symbol sequence by multiplying the input symbol sequence by e^{jθ}, θ being a phase rotation angle, in case of QPSK in range of 0≦θ≦90, 23.5≦θ≦24.5, or 65.5≦θ≦66.5, in case of 16QAM in range of 0≦θ≦90, 15.5≦θ≦17.5 or 72.5≦θ≦74.5, the pre-coded symbol sequence being reconstructed to have real and imaginary parts. A mapper generates symbol vectors by recombining the real and imaginary parts of the pre-coded symbol sequence in an interleaving scheme. A plurality of Alamouti coders encodes the symbol vectors in an Alamouti scheme and transmits the encoded symbol vectors through corresponding transmit antennas.

### PRIORITY

This application claims priority under 35 U.S.C. § 119 to an application entitled “Apparatus And Method For Space-Time Block Coding For Increasing Coding Gain” filed in the Korean Intellectual Property Office on Aug. 17, 2004 and assigned Ser. No. 2004-0064900, the contents of which are herein incorporated by reference.

### BACKGROUND OF THE INVENTION

1. Field of the Invention

The present invention relates generally to a transmit (Tx) antenna diversity apparatus and method in a mobile communication system, and in particular, to a space-time block coding apparatus and method in a mobile communication system using multiple antennas in order to maximize a coding gain.

2. Description of the Related Art

A fundamental issue in communications is the efficiency and reliability with which data is transmitted on channels. As future-generation multimedia mobile communications require high-speed communication systems capable of transmitting a variety of information including video and wireless data beyond the voice-focused service, it is very significant to increase system efficiency by using a channel coding method suitable for a system.

Generally, a transmission signal in a wireless channel environment of a mobile communication system inevitably experiences loss due to several factors such as multipath interference, shadowing, wave attenuation, time-variant noise, and fading. The information loss causes a severe distortion to the transmission signal, degrading an entire system performance. In order to reduce the information loss, many error control techniques are usually utilized to increase system reliability. A basic error control technique is to use an error correction code.

Additionally, multipath fading is relieved by diversity techniques in the wireless communication system. The diversity techniques are time diversity, frequency diversity, and antenna diversity. Antenna diversity uses multiple antennas and is further branched into receive (Rx) antenna diversity using a plurality of Rx antennas, Tx antenna diversity using a plurality of Tx antennas, and multiple-input multiple-output (MIMO) using a plurality of Tx antennas and a plurality of Rx antennas.

MIMO is a special case of space-time coding (STC) that extends coding of the time domain to the space domain by transmission of a signal encoded in a predetermined coding method through a plurality of Tx antennas, with the intentions of achieving a lower error rate.

V. Tarokh et al. proposed space-time block coding (STBC) as one of methods of efficiently applying antenna diversity (see “Space-Time Block Coding from Orthogonal Designs”, IEEE Trans. On Info., Theory, Vol. 45, pp. 1456-1467, July 1999). The Tarokh STBC scheme is an extension of the transmit antenna diversity scheme of S. M. Alamouti (see, “A Simple Transmit Diversity Technique for Wireless Communications”, IEEE Journal on Selected Area in Communications, Vol. 16, pp. 1451-1458, October 1988), for two or more Tx antennas.

FIG. 1 is a block diagram of a transmitter in a mobile communication system using the conventional Tarokh's STBC scheme. Referring to FIG. 1, the transmitter includes a modulator 100, a serial-to-parallel (S/P) converter 102, an STBC coder 104, and four Tx antennas 106, 108, 110, and 112. The modulator 100 modulates input information data (or coded data) in a predetermined modulation scheme. The modulation scheme can be one of binary phase shift keying (BPSK), quadrature phase shift keying (QPSK), quadrature amplitude modulation (QAM), pulse amplitude modulation (PAM), and phase shift keying (PSK).

The S/P converter 102 parallelizes serial modulation symbols received from the modulator 100, s₁, s₂, s₃, s₄. The STBC coder 104 creates eight symbol combinations by STBC-encoding the four modulation symbols, s₁, s₂, s₃, s₄ and sequentially transmits them through the four Tx antennas 106 to 112. A coding matrix used to generate the eight symbol combinations is expressed as shown in Equation (1),

$${G}_{4} = [ \begin{matrix}{s}_{1} & {s}_{2} & {s}_{3} & {s}_{4} \\ - {s}_{2} & {s}_{1} & - {s}_{4} & {s}_{3} \\ - {s}_{3} & {s}_{4} & {s}_{1} & - {s}_{2} \\ - {s}_{4} & - {s}_{3} & {s}_{2} & {s}_{1} \\ {s}_{1}^{*} & {s}_{2}^{*} & {s}_{3}^{*} & {s}_{4}^{*} \\ - {s}_{2}^{*} & {s}_{1}^{*} & - {s}_{4}^{*} & {s}_{3}^{*} \\ - {s}_{3}^{*} & {s}_{4}^{*} & {s}_{1}^{*} & - {s}_{2}^{*} \\ - {s}_{4}^{*} & - {s}_{3}^{*} & {s}_{2}^{*} & {s}_{1}^{*}\end{matrix} ] \qquad ( 1 )$$

where G₄ denotes the coding matrix for symbols transmitted through the four Tx antennas 106 to 112 and s₁, s₂, s₃, s₄ denote the input four symbols. The number of columns of the coding matrix is equal to that the number of Tx antennas and the number of rows corresponds to the time required to transmit the four symbols. Therefore, the four symbols are transmitted through the four Tx antennas for eight time intervals.

More specifically, for a first time interval, s₁ is transmitted through the first Tx antenna 106, s₂ through the second Tx antenna 108, s₃ through the third Tx antenna 110, and s₄ through the fourth Tx antenna 112. In this manner, −s₄*, −s₃*, s₂*, −s₁* are transmitted through the first to fourth Tx antennas 106 to 112, respectively for an eighth time interval. That is, the STBC coder 104 sequentially provides the symbols of an i^{th} column in the coding matrix to an i^{th} Tx antenna.

As described above, the STBC coder 104 generates eight symbol sequences using the input four symbols, their conjugates and negatives, and transmits them through the four Tx antennas 106 to 112 for eight time intervals. Because the symbol sequences for the respective Tx antennas, that is, the columns of the coding matrix, are mutually orthogonal, as high a diversity gain as a diversity order is achieved.

FIG. 2 is a block diagram of a receiver in the mobile communication system using the conventional STBC scheme. More specifically, the receiver in FIG. 2 is the counterpart of the transmitter illustrated in FIG. 1.

Referring to FIG. 2, the receiver includes a plurality of Rx antennas 200 to 202, a channel estimator 204, a signal combiner 206, a detector 208, a parallel-to-serial (P/S) converter 210, and a demodulator 212. The first to P^{th} Rx antennas 200 to 202 provide signals received from the four Tx antennas of the transmitter illustrated in FIG. 1 to the channel estimator 204 and the signal combiner 206. The channel estimator 204 estimates channel coefficients representing channel gains from the Tx antennas 106 to 112 to the Rx antennas 200 to 202 using the signals received from the first to P^{th} Rx antennas 200 to 202. The signal combiner 206 combines the signals received from the first to P^{th} Rx antennas 200 to 202 with the channel coefficients in a predetermined method. The detector 208 generates hypothesis symbols by multiplying the combined symbols by the channel coefficients, calculates decision statistics for all possible transmitted symbols from the transmitter using the hypothesis symbols, and detects the actual transmitted symbols through threshold detection. The P/S converter 210 serializes the parallel symbols received from the detector 208, and the demodulator 212 demodulates the serial symbol sequence in a predetermined demodulation method, thereby recovering the original information bits.

As described above, the Alamouti STBC technique offers the benefit of achieving as high a diversity order as the number of Tx antennas, namely a full diversity order, without sacrificing data rate by transmitting complex symbols through only two Tx antennas.

The Tarokh STBC scheme, which is extended from the Alamouti STBC scheme, achieves a full diversity order using an STBC in the form of a matrix with orthogonal columns, as described above with reference to FIGS. 1 and 2. However, because four complex symbols are transmitted for eight time intervals, the Tarokh STBC scheme decreases the data rate by half. In addition, because it takes eight time intervals to completely transmit one block with four complex symbols, reception performance is degraded due to channel changes within the block over a fast fading channel. That is, the transmission of complex symbols through four or more Tx antennas requires 2N time intervals for N symbols, causing a longer latency and a decrease in data rate.

To achieve a full rate in a MIMO system that transmits a complex signal through three or more Tx antennas, the Giannakis group presented a full-diversity, full-rate (FDFR) STBC for four Tx antennas using constellation rotation over a complex field.

FIG. 3 is a block diagram of a transmitter in a mobile communication system using a conventional Giannakis STBC scheme. Referring to FIG. 3, the transmitter includes a modulator 300, a pre-coder 302, a space-time mapper 304, and a plurality of Tx antennas 306, 308, 310 and 312. The modulator 300 modulates input information data (or coded data) in a predetermined modulation scheme such as BPSK, QPSK, QAM, PAM or PSK. The pre-coder 302 pre-encodes Nₜ modulation symbols received from the modulator 300, d₁, d₂, d₃, d₄ such that signal rotation occurs in a signal space, and outputs the resulting Nₜ symbols. For notational simplicity, four Tx antennas are assumed. Further, a sequence of four modulation symbols from the modulator 300 is denoted by d. The pre-coder 302 generates a complex vector r by computing the modulation symbol sequence, d using Equation (2),

$$r = Θ d = [ \begin{matrix}1 & {α}_{0}^{1} & {α}_{0}^{2} & {α}_{0}^{3} \\ 1 & {α}_{1}^{1} & {α}_{1}^{2} & {α}_{1}^{3} \\ 1 & {α}_{2}^{1} & {α}_{2}^{2} & {α}_{2}^{3} \\ 1 & {α}_{3}^{1} & {α}_{3}^{2} & {α}_{3}^{3}\end{matrix} ] [ \begin{matrix}{d}_{1} \\ {d}_{2} \\ {d}_{3} \\ {d}_{4}\end{matrix} ] = [ \begin{matrix}{r}_{1} \\ {r}_{2} \\ {r}_{3} \\ {r}_{4}\end{matrix} ] \qquad ( 2 )$$

where Θ denotes a pre-coding matrix. The Giannakis group uses a Vandermonde matrix, which is a unitary, like the pre-coding matrix. In the pre-coding matrix, αᵢ can be expressed as shown in Equation (3).
αᵢ=exp(j2π(i+¼)/4), i=0, 1, 2, 3 (3)

The Giannakis STBC scheme uses four Tx antennas and is easily extended to more than four Tx antennas, as well. The space-time mapper 304 STBC-encodes the pre-coded symbols using Equation (4),

$$S = [ \begin{matrix}{r}_{1} & 0 & 0 & 0 \\ 0 & {r}_{2} & 0 & 0 \\ 0 & 0 & {r}_{3} & 0 \\ 0 & 0 & 0 & {r}_{4}\end{matrix} ] \qquad ( 4 )$$

where S is a coding matrix for symbols transmitted through the four Tx antennas 306 to 312. The number of columns of the coding matrix is equal to that the number of Tx antennas and the number of rows corresponds to the time required to transmit the four symbols. That is, the four symbols are transmitted through the four Tx antennas for the four time intervals.

More specifically, for a first time interval, r₁ is transmitted through the first Tx antenna 306, with no signals through the other Tx antennas 308, 310, and 312. For a second time interval, r₂ is transmitted through the second Tx antenna 308, with no signals through the other Tx antennas 306, 310, and 312. For a third time interval, r₃ is transmitted through the third Tx antenna 310, with no signals through the other Tx antennas 306, 308, and 312. For a fourth time interval, r₄ is transmitted through the fourth Tx antenna 310, with no signals through the other Tx antennas 306, 308, and 310.

Upon receipt of the four symbols on a radio channel for the four time intervals, a receiver (not shown) recovers the modulation symbol sequence d by maximum likelihood (ML) decoding.

In 2003, Tae-Jin Jung and Kyung-Whoon Cheun proposed a pre-coder and a concatenated code with an excellent coding gain, when compared to the Giannakis STBC. In their work, they enhance the coding gain by concatenating Alamouti STBCs, instead of using a diagonal matrix proposed by the Giannakis group. Herein, their STBC will be called an “Alamouti FDFR STBC”.

FIG. 4 is a block diagram of a transmitter in a mobile communication system using a conventional Alamouti FDFR STBC for four Tx antennas. Referring to FIG. 4, the transmitter includes a pre-coder 400, a mapper 402, a delay 404, two Alamouti coders 406 and 408, and four Tx antennas 410, 412, 414, and 416. The pre-coder 400 pre-encodes input four modulation symbols, d₁, d₂, d₃, d₄ such that signal rotation occurs in a signal space. For the input of a sequence of the four modulation symbols, d, the pre-coder 400 generates a complex vector r using Equation (5),

$$r = Θ d = [ \begin{matrix}1 & {α}_{0}^{1} & {α}_{0}^{2} & {α}_{0}^{3} \\ 1 & {α}_{1}^{1} & {α}_{1}^{2} & {α}_{1}^{3} \\ 1 & {α}_{2}^{1} & {α}_{2}^{2} & {α}_{2}^{3} \\ 1 & {α}_{3}^{1} & {α}_{3}^{2} & {α}_{3}^{3}\end{matrix} ] [ \begin{matrix}{d}_{1} \\ {d}_{2} \\ {d}_{3} \\ {d}_{4}\end{matrix} ] = [ \begin{matrix}{r}_{1} \\ {r}_{2} \\ {r}_{3} \\ {r}_{4}\end{matrix} ] \qquad ( 5 )$$

where αᵢ=exp(j2π(i+¼)/4), i=0, 1, 2, 3.

The mapper 402 groups the four pre-coded symbols by twos and outputs two vectors, each including two elements, [r₁, r₂]^{T} and [r₃, r₄]^{T} to the Alamouti coder 406 and the delay 404, respectively.

The delay 404 delays the second vector [r₃, r₄]^{T} for one time interval. Accordingly, the first vector [r₁, r₂]^{T} is provided to the Alamouti coder 406 in a first time interval and the second vector [r₃, r₄]^{T} is provided to the Alamouti coder 408 in a second time interval. The Alamouti coder refers to a coder that operates in the Alamouti STBC scheme.

The Alamouti coder 406 encodes [r₁, r₂]^{T} so that it is transmitted through the first and second Tx antennas 410 and 412 for first and second time intervals. The Alamouti coder 408 encodes [r₃, r₄]^{T} so that it is transmitted through the third and fourth Tx antennas 414 and 416 for third and fourth time intervals. A coding matrix used to transmit the four symbols from the mapper 402 through the multiple antennas is shown in Equation (6).

$$S = [ \begin{matrix}{r}_{1} & {r}_{2} & 0 & 0 \\ - {r}_{2}^{*} & {r}_{1}^{*} & 0 & 0 \\ 0 & 0 & {r}_{3} & {r}_{4} \\ 0 & 0 & - {r}_{4}^{*} & {r}_{3}^{*}\end{matrix} ] \qquad ( 6 )$$

Unlike the coding matrix illustrated in Equation (4), the coding matrix in Equation (6) is designed to be an Alamouti STBC rather than a diagonal matrix. The use of the Alamouti STBC scheme increases a coding gain.

This Alamouti FDFR STBC, however, has the distinctive shortcoming of increased coding complexity because the transmitter needs to perform computations between all elements of the pre-coding matrix and an input vector, for pre-coding. For example, for four Tx antennas, because 0 is not included in the elements of the pre-coding matrix, computations must be performed on 16 elements. Also, the receiver needs to perform ML decoding with a large volume of computation in order to decode the signal d transmitted by the transmitter.

To reduce such high complexity, Chan-Byoung Chae et al. of Samsung Electronics proposed a novel STBC, which is shown below in Equation (7).

$$Θ = [ \begin{matrix}1 & {α}_{0}^{1} & ⋯ & {α}_{0}^{{N}_{t} / 2 - 1} & 0 & ⋯ & 0 \\ 0 & 0 & ⋯ & 0 & 1 & ⋯ & {α}_{1}^{{N}_{t} / 2 - 1} \\ ⋮ & ⋮ & ⋰ & ⋯ & ⋯ & ⋰ & ⋮ \\ 1 & {α}_{{N}_{t} - 2}^{1} & ⋯ & {α}_{{N}_{t} - 2}^{{N}_{t} / 2 - 1} & 0 & ⋯ & 0 \\ 0 & 0 & ⋯ & 0 & 1 & ⋯ & {α}_{{N}_{t} - 1}^{{N}_{t} / 2 - 1}\end{matrix} ] \qquad ( 7 )$$

In Equation (7), Θ is a pre-coding matrix for an arbitrary even number of Tx antennas. The subsequent operations are performed in the same manner as done in Cheun's group. However, compared to the FDFR Alamouti STBC scheme, Chae's scheme is remarkably reduces ML (Maximum Likelihood) decoding complexity at the receiver through a series of operations, that is, puncturing and shifting.

However, all the approaches described above suffer from high decoding complexity relative to the Alamouti scheme that allows linear decoding of transmitted symbols, and thus continual efforts have been made to further decrease the decoding complexity.

In this context, Professor Sundar Rajan's group (hereinafter, referred to as Sundar Rajan group) presented an FDFR STBC that enables linear decoding. For the Sundar Rajan group's STBC, every value rᵢ of the coding matrix illustrated in Equation (6) is multiplied by e^{jθ} (i.e., rotation on a complex plane), and the real and imaginary parts of the resulting new value xᵢ+jyᵢ are reconstructed. The coding matrix produced in this way is expressed in Equation (8).

$$S = [ \begin{matrix}{x}_{1} + j {y}_{3} & {x}_{2} + j {y}_{4} & 0 & 0 \\ - {( {x}_{2} + j {y}_{4} )}^{*} & {( {x}_{1} + j {y}_{3} )}^{*} & 0 & 0 \\ 0 & 0 & {x}_{3} + j {y}_{1} & {x}_{4} + j {y}_{2} \\ 0 & 0 & - {( {x}_{4} + j {y}_{2} )}^{*} & {( {x}_{3} + j {y}_{1} )}^{*}\end{matrix} ] \qquad ( 8 )$$

In Equation (8), xᵢ+jyᵢ is value, which is a product of input information symbols multiplied by e^{jθ} (i.e., rotation on a complex plane).

The use of Equation (8) enables linear decoding at the receiver, thereby decreasing decoding complexity. Professor Sundar Rajan uses a fixed phase rotation angle θ. Here, θ==(½)atan2.

A mobile communication system using the Sundar Rajan group's STBC scheme adopts a transmitter having the configuration illustrated in FIG. 5. Information symbols s₁, s₂, s₃, s₄ are multiplied by exp(jθ) in a pre-coder 500 and then reconstructed in a mapper 502. More specifically, the mapper reconstructs pre-coded symbols cᵢ=xᵢ+jyᵢ to c₁′=x₁+jy₃, c₂′=x₂+jy₄, c₃′=x₃+jy₁, and c₄′=x₄+jy₂, and groups the reconstructed symbols in pairs to vectors [c₂′c₁′] and [c₄′c₃′]. The vectors [c₂′c₁′] and [c₄′c₃′] are transmitted through their corresponding Alamouti coders 506 and 508.

To illustrate that the coding gain or coding advantage of the Sundar Rajan group's STBC can be further improved, a design of a space-time code will be described below.

Two designs of a space-time trellis code were proposed in a paper by Tarokh in 1997. However, before explaining the design rule, pairwise error probability of the space-time trellis code will be described. Equation (9) is an equation representing pairwise error probability of the space-time trellis code.

$$p ( c \to e ) \leq {( {\prod }_{n = 1}^{r} {λ}_{n} )}^{- M} {( \frac{{E}_{s}}{4 {N}_{0}} )}^{- rM} \qquad ( 9 )$$

In Equation (9), r denotes a rank of a c→e matrix, M denotes the number of Rx antennas, and λ denotes a diagonal term of the c→e matrix. Eₛ denotes symbol energy and N₀ denotes noise. In a right-hand side of Equation (9), a first term is a determinant criterion representing a coding gain or coding advantage and a second term is a rank criterion representing a diversity gain.

1) Determinant Criterion: It is a design condition for maximizing coding gain and the product of λ₁, . . . λᵣ must be designed to have the largest code in order to obtain the large coding gain.

2) Rank Criterion: It is a design condition for maximizing diversity gain and must be designed to have a full rank.

Regarding the coding gain, the Sudar Rajan group calculated θ by applying the design rule 1) to the space-time block coding. This method is achieved by maximizing a minimum value among the products of Eigen values (not zero) of N×M matrices A(c, e) corresponding to this a difference (c−e) between two different signal vectors. If calculating θ by this method, θ is equal to about 59°.

FIG. 8 is a graph of coding gain by two-dimensional phase rotation. A minimum coding gain obtained by the design rule proposed by Tarokh was found while changing θ from 0 to 90. As illustrated in FIG. 8, it can be seen that the coding gain is greatest at a phase of 59°. In an actual simulation, however, the use of this value degrades the system performance.

For example, if a phase rotation angel θ is calculated using the Tarokh's design rule, the phase rotation angle θ is 59°. In this case, the minimum coding gain is 1.7659 and happens 2048 times when QPSK is assumed. The second smallest coding gain is 1.8779 and happens 1924 times. The third smallest coding gain is 3.5318 and happens 3072 times. The fourth smallest coding gain is 3.7558 and happens 768 times. If 63.43° is assumed, however, the minimum coding gain is 1.6002 and happens 2048 times. The second smallest coding gain is 2.3994 and happens 1024 times. The third smallest coding gain is 3.2001 and happens 3072 times. The fourth smallest coding gain is 4.000 and happens 3072 times. According to the design rule, compared with the two cases, the performance must be better in the use of 59° at which the coding gain is good. However, the performance is better in the use of 63.43° as illustrated in FIG. 10. That is, as shown by FIG. 10, the design rule 1) is not perfect. Accordingly, there is a need for a method of further improving the coding gain at the Sudar Rajan group's transmitter.

### SUMMARY OF THE INVENTION

Accordingly, the present invention has been designed to substantially solve at least the above problems and/or disadvantages and to provide at least the advantages below. An object of the present invention is to provide a space-time block coding apparatus and method for improving coding gain in a mobile communication system with a plurality of antennas.

Another object of the present invention is to provide a space-time block coding apparatus and method for maximizing coding gain in a mobile communication system using a plurality of antennas, wherein vector symbols are rotated on a complex plane and the real and imaginary parts of the resulting new symbols xᵢ+jyᵢ are reconstructed, prior to transmission.

A further object of the present invention is to provide a space-time block coding apparatus and method providing phase rotation value for maximizing coding gain in a communication system using multiple antennas, wherein vector symbols are rotated on a complex plane and the real and imaginary parts of the resulting new symbols xᵢ+jyᵢ are reconstructed, prior to transmission.

A further object of the present invention is to provide a space-time block coding apparatus and method providing phase rotation value for maximizing coding gain in a communication system using even number of antennas, wherein vector symbols are rotated on a complex plane and the real and imaginary parts of the resulting new symbols xᵢ+jyᵢ are reconstructed, prior to transmission.

A further object of the present invention is to provide a space-time block coding apparatus and method providing phase rotation value for maximizing coding gain in a communication system using even number of multiple antennas, wherein vector symbols are rotated on a complex plane and the real and imaginary parts of the resulting new symbols xᵢ+jyᵢ are reconstructed, prior to transmission.

According to one aspect of the present invention, in a transmitter with four transmit antennas in a system using a space-time block coding scheme, a pre-coder pre-codes an input symbol sequence by multiplying the input symbol sequence by e^{jθ}, θ being a phase rotation angle, in case of QPSK in range of 0≦θ≦90, 23.5≦θ≦24.5, or 65.5≦θ≦66.5, in case of 16QAM in range of 0≦θ≦90, 15.5≦θ≦17.5 or 72.5≦θ≦74.5, the pre-coded symbol sequence being reconstructed to have real and imaginary parts. A mapper generates symbol vectors by recombining the real and imaginary parts of the pre-coded symbol sequence in an interleaving scheme. A plurality of Alamouti coders encodes the symbol vectors in an Alamouti scheme and transmits the encoded symbol vectors through corresponding transmit antennas.

According to another aspect of the present invention, in a space-time block coding method in a transmitter with a plurality of transmit antennas, an input symbol sequence is pre-coded by multiplying the input symbol sequence by e^{jθ}, θ being a phase rotation angle, in case of QPSK in range of 0≦θ≦90, 23.5≦θ≦24.5, or 65.5≦θ≦66.5, in case of 16QAM in range of 0≦θ≦90, 15.5≦θ≦17.5, or 72.5≦θ≦74.5. The pre-coded symbol sequence is reconstructed to have real and imaginary parts. Symbol vectors are generated by recombining the real and imaginary parts of the pre-coded symbol sequence in an interleaving scheme. The symbol vectors are encoded in an Alamouti scheme and the encoded symbol vectors are transmitted through corresponding transmit antennas.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram of a transmitter in a mobile communication system using a conventional STBC scheme;

FIG. 2 is a block diagram of a receiver in a mobile communication system using a conventional STBC scheme;

FIG. 3 is a block diagram of a transmitter in a mobile communication system using a conventional Giannakis STBC scheme;

FIG. 4 is a block diagram of a transmitter in a mobile communication system using a conventional Alamouti FDFR STBC scheme with four Tx antennas proposed by Tae-Jin Jung and Kyung-Whoon Cheun;

FIG. 5 is a block diagram of a transmitter in a mobile communication system using a Sundar Rajan group's STBC scheme;

FIG. 6 is a flowchart illustrating a transmission operation of a transmitter in a mobile communication system using an STBC scheme according to the present invention;

FIG. 7 is a block diagram of a transmitter in a mobile communication system using an STBC scheme based on two-dimensional phase rotation according to the present invention;

FIG. 8 is a graph illustrating coding gain based on a conventional code design proposed by Tarokh;

FIG. 9 is a graph illustrating coding gain based on two-dimensional phase rotation according to the present invention; and

FIG. 10 is a graph illustrating performance comparison between the prior art and the present invention.

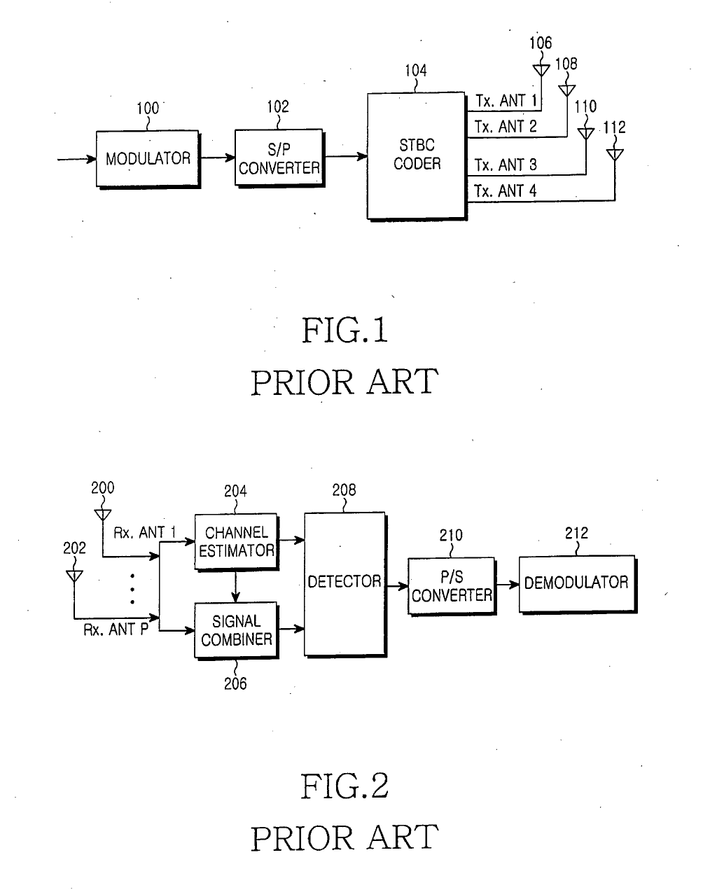

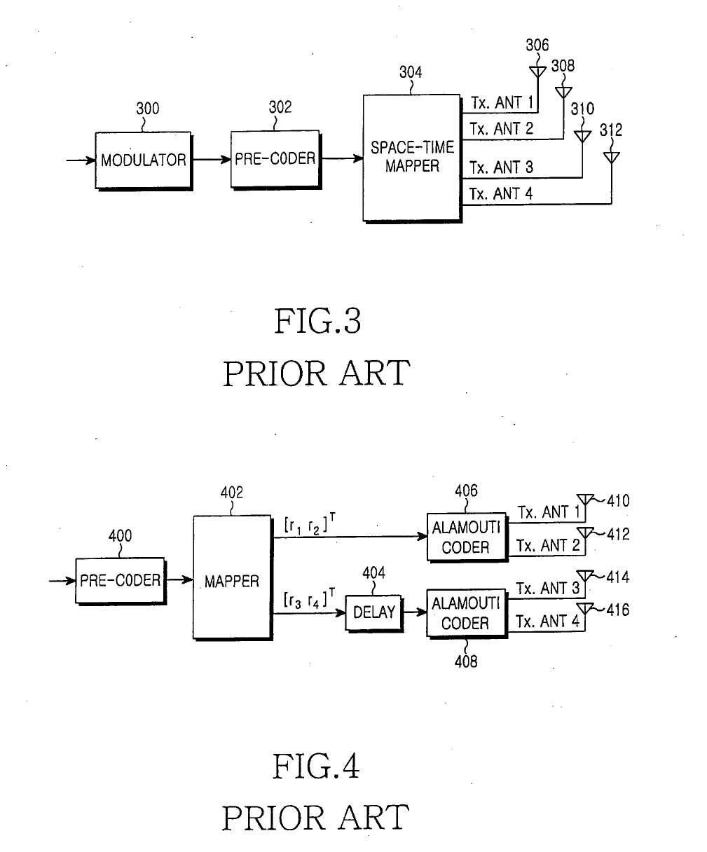

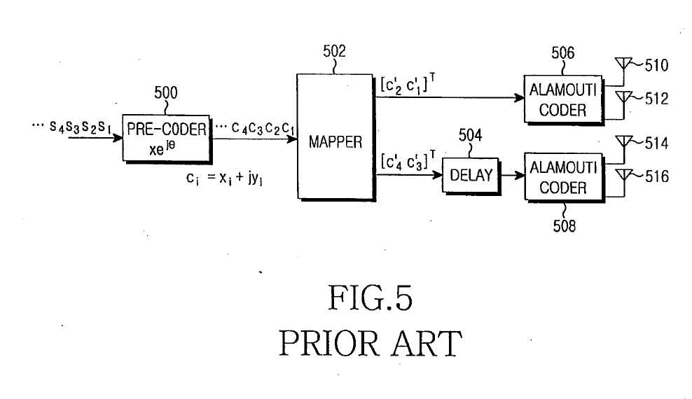

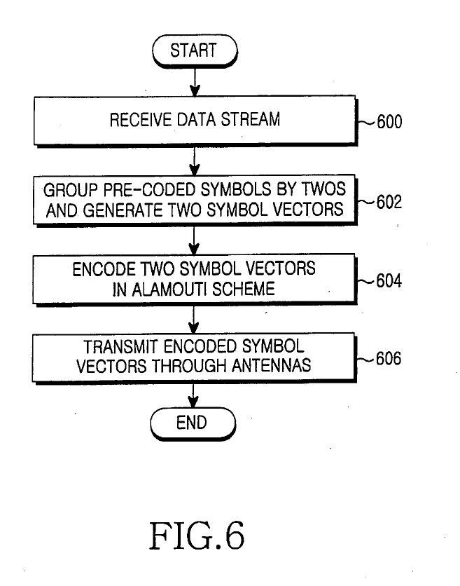

### DETAILED DESCRIPTION OF THE PREFERRED EMBODIMENTS

Preferred embodiments of the present invention will be described in detail herein below with reference to the accompanying drawings. In the following description, well-known functions or constructions are not described in detail since they would obscure the invention in unnecessary detail.

Generally, the present invention is intended to provide a space-time block coding apparatus in a transmitter having a plurality of antennas, e.g., four antennas are assumed in the following embodiments, in a communication system. An input symbol stream is transmitted through a plurality of Tx antennas in a predetermined method in order to maximize coding gain of a space-time block coding.

A transmitter in a communication system according to the present invention uses four antennas. When new value xᵢ+jyᵢ is obtained by multiplying a symbol vector by e^{jθ}, θ being a phase rotation angle, it can be checked that the calculation of the space-time block coding by using the design rule proposed by Tarokh is more degraded. Therefore, the present invention improves coding gain in other methods. That is, coding gains of all possible cases are calculated and the number of their occurrences is checked. Thereafter, a mean coding gain is calculated. The phase rotation angle θ having the largest mean coding gain is calculated using Equation (10).

$$arg {max}_{θ} mean ( C . A . ) \qquad ( 10 )$$

Using Equation (10), the improvement of the coding gain can be seen. In Equation (10), (C.A.) represents a coding advantage or coding gain. Further, in Equation (10), a mean value of coding gains of an input symbol sequence set is calculated while changing the value of θ, and the value of θ at which the mean value is maximized is calculated.

In order to emphasize that Equation (10) is applied to all possible phase rotation angles θ, Equation (10) is often expressed as shown in Equation (11).

$$arg {max}_{θ} mean {( C . A . )}_{over all possible θ} \qquad ( 11 )$$

If θ is obtained using Equation (11), in the case of QPSK in range of 0≦θ≦90, 23.5≦θ≦24.5, or 65.5≦θ≦66.5. In the case of QPSK in range of 90<θ, 23.5+90n≦θ≦24.5+90n, or 65.5+90n≦θ≦66.5+90n. In the case of 16QAM in range of 0≦θ≦90, 15.5≦θ≦17.5, or 72.5≦θ≦74.5. In the case of 16QAM in range of 90<θ, 15.5n≦0≦17.5n, or 72.5n≦0≦74.5n. Here, n represent integers. These values are different from θ=(½)atan2 proposed by Sundar Rajan.

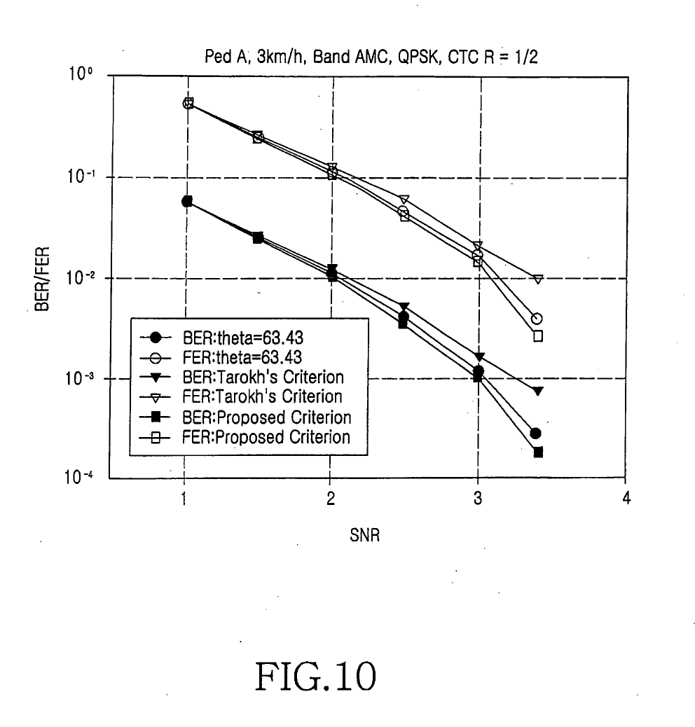

FIG. 10 is a graph illustrating performance comparison of the case of θ=59 calculated using the Tarokh's design rule, the case of θ=63.43, and the case of the present invention. As can be seen from FIG. 10, the case of the present invention is the best, the case of θ=63.54 is bettering the middle, and the case of θ=59 is the worst.

The graph illustrated in FIG. 10 was obtained by a simulation using system environment based on IEEE 802.16 for verifying the performance. Simulation conditions were that a mobile terminal was assumed to move at 3 km/h in Pedestrian A channel, and QPSK and channel coding having a convolutional Turbo code (½ code rate) was used. In this case, the method according to the present invention had the best performance. In this simulation, band AMC among IEEE 802.16 standards was used.

According to another embodiment of the present invention, a space-time block coding supports a full diversity and full rate in a transmission system using an even number of antennas.

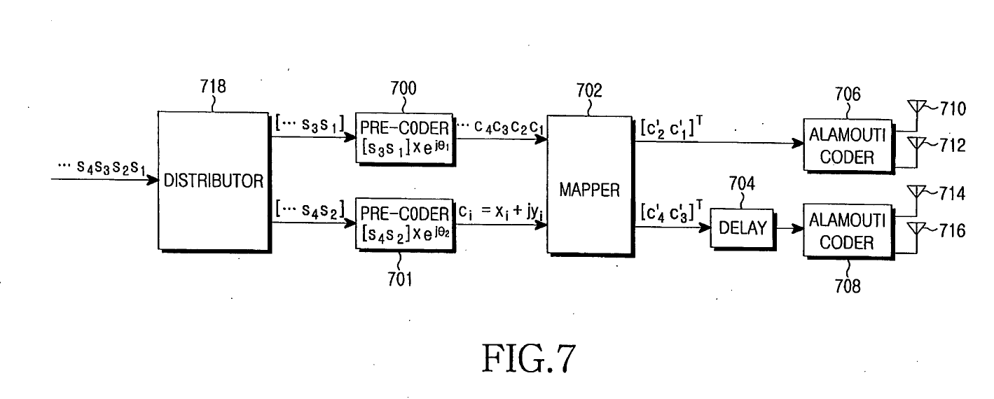

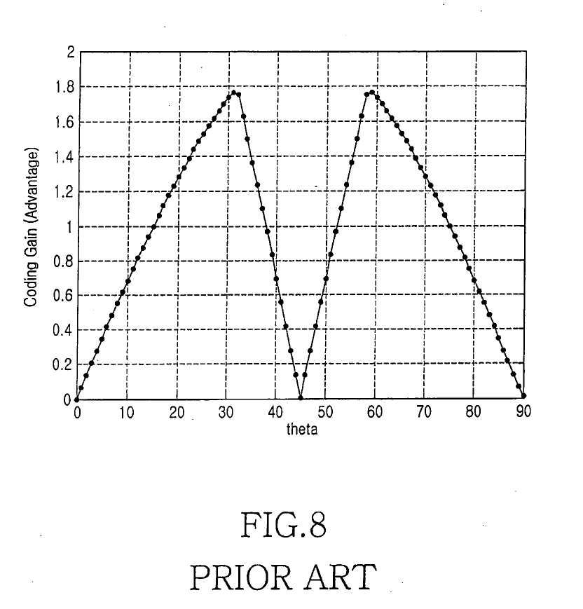

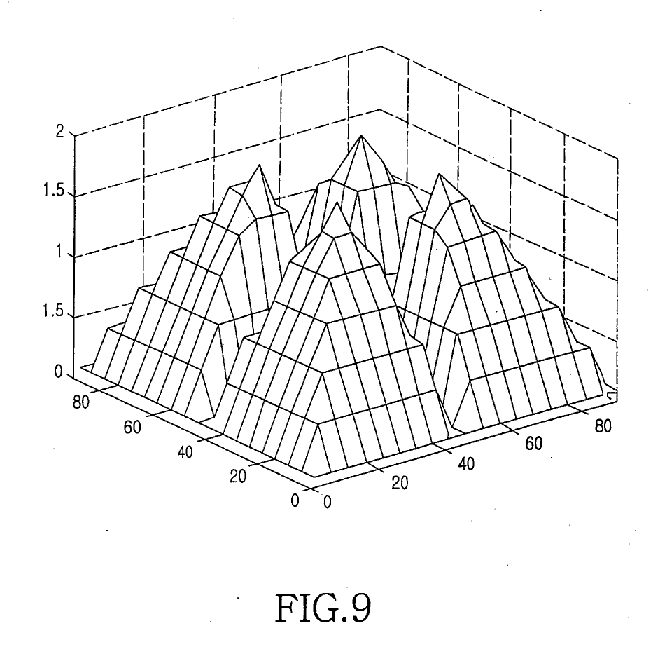

FIG. 7 is a block diagram of a system according to the present invention. The system is similar to the existing Sundar Rajan group's system, but a pre-coder is modified such that design can be made more freely. That is, unlike the conventional pre-coder 500 that multiplies information symbol by exp(jθ), even symbols and odd symbols are multiplied by different phase rotators. Thereafter, the symbols pass through a mapper 702, a delay 704, and Alamouti coders 706 and 708, and are then transmitted through Tx antennas 710-716. That is, two-dimensional phase rotation is proposed. In this case, minimum coding gain is illustrated in FIG. 9. A distributer 718 distributes input information symbols into pre-coders 700 and 701. The pre-coders precodes the information symbols from the distributer. A mapper maps the pre-coded symbols into the corresponding alamouti coders 706 and 708.

In the STBC apparatus and method of the transmitter using a plurality of Tx antennas, the phase rotation angle θ calculated by

$$arg {max}_{θ} mean {( C . A . )}_{over all possible θ}$$

is used, and the input symbol sequence is transmitted through a plurality of Tx antennas according to a predetermined method, thereby maximizing coding gain of the space-time block coding.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A transmitter having a plurality of transmit antennas in a communication system using a space-time block coding scheme, the transmitter comprising:
a pre-coder for pre-coding an input symbol sequence by multiplying the input symbol sequence by e^{jθ}, θ being calculated as a phase rotation angle by
$$arg {max}_{θ} mean {( C . A . )}_{over all possible θ} ,$$
into a pre-coded symbol sequence being reconstructed to have real and imaginary parts;
a mapper for generating symbol vectors by recombining the real and imaginary parts of the pre-coded symbol sequence using an interleaving scheme; and
a plurality of Alamouti coders for encoding the symbol vectors using an Alamouti scheme and transmitting the encoded symbol vectors through the plurality of transmit antennas.

2. The transmitter of claim 1, wherein the transmitter provides a full diversity and full rate.

3. The transmitter of claim 1, wherein an i^{th} coder of the plurality of Alamouti coders encodes an i^{th} symbol vector using the Alamouti scheme and transmits the encoded symbol vector through (2i−1)^{th} and 2i^{th} antennas during (2i−1)^{th} and 2i^{th} time intervals.

4. The transmitter of claim 1, wherein the recombining is performed by grouping the real and imaginary parts by twos.

5. A method of space-time block coding in a transmitter having a plurality of transmit antennas, comprising the steps of:
pre-coding an input symbol sequence by multiplying the input symbol sequence by e^{jθ}, θ being calculated as a phase rotation angle by
$$arg {max}_{θ} mean {( C . A . )}_{over all possible θ} ,$$
into a pre-coded symbol sequence being reconstructed to have real and imaginary parts;
generating symbol vectors by recombining the real and imaginary parts of the pre-coded symbol sequence using an interleaving scheme;
encoding the symbol vectors using an Alamouti scheme; and
transmitting the Alamouti encoded symbol vectors through the plurality of transmit antennas.

6. The space-time block coding method of claim 5, wherein an i^{th} coder of Alamouti coders encodes an i^{th} symbol vector using the Alamouti scheme and transmits the encoded symbol vector through (2i−1)^{th} and 2i^{th} antennas during (2i−1)^{th} and 2i^{th} time intervals.

7. The space-time block coding method of claim 5, wherein the recombining is performed by grouping the real and imaginary parts by twos.

8. A transmitter having four transmit antennas in a system using a space-time block coding scheme, the transmitter comprising:
a pre-coder for pre-coding an input symbol sequence by multiplying the input symbol sequence by e^{jθ}, θ being a phase rotation angle, in case of QPSK in range of 0≦θ≦90, 23.5≦θ≦24.5, or 65.5≦θ≦66.5, in case of 16QAM in range of 0≦θ≦90, 15.5≦θ≦17.5 or 72.5≦θ≦74.5, into a pre-coded symbol sequence being reconstructed to have real and imaginary parts;
a mapper for generating symbol vectors by recombining the real and imaginary parts of the pre-coded symbol sequence using an interleaving scheme; and
a plurality of Alamouti coders for encoding the symbol vectors using an Alamouti scheme and transmitting the encoded symbol vectors through the four transmit antennas.

9. The transmitter of claim 8, wherein the transmitter provides full diversity and full rate.

10. The transmitter of claim 8, wherein an i^{th} coder of the Alamouti coders encodes an i^{th} symbol vector using the Alamouti scheme and transmits the encoded symbol vector through (2i−1)^{th} and 2i^{th} antennas during (2i−1)^{th} and 2i^{th} time intervals.

11. The transmitter of claim 8, wherein the recombining is performed by grouping the real and imaginary parts by twos.

12. A transmitter having four transmit antennas in a system using a space-time block coding scheme, comprising:
a pre-coder for pre-coding an input symbol sequence by multiplying the input symbol sequence by e^{jθ}, θ being a phase rotation angle, in case of QPSK in range of 90<θ, 23.5+90n≦θ≦24.5+90n, or 65.5+90n≦θ≦66.5+90n, in case of 16QAM in range of 90<θ, 15.5n≦θ≦17.5n, or 72.5n≦θ≦74.5n, where n is an integer, into a pre-coded symbol sequence being reconstructed to have real and imaginary parts;
a mapper for generating symbol vectors by recombining the real and imaginary parts of the pre-coded symbol sequence using an interleaving scheme; and
a plurality of Alamouti coders for encoding the symbol vectors using an Alamouti scheme and transmitting the encoded symbol vectors through the four transmit antennas.

13. The transmitter of claim 12, wherein an i^{th} coder of the Alamouti coders encodes an i^{th} symbol vector in the Alamouti scheme and transmits the encoded symbol vector through (2i−1)^{th} and 2i^{th} antennas during (2i−1)^{th} and 2i^{th} time intervals.

14. A transmitter having an even number of transmit antennas in a system using a space-time block coding scheme, the transmitter comprising:
a pre-coder for pre-coding an input symbol sequence by multiplying even columns of the input symbol sequence by exp(jθ₁) and multiplying odd columns of the input symbol sequence by exp(jθ₂) according to a predetermined modulation scheme, into a pre-coded symbol sequence being reconstructed to have real and imaginary parts;
a mapper for generating symbol vectors by recombining the real and imaginary parts of the pre-coded symbol sequence using an interleaving scheme; and
a plurality of Alamouti coders for encoding the symbol vectors using an Alamouti scheme and transmitting the encoded symbol vectors through the four transmit antennas.

15. The transmitter of claim 14, wherein an i^{th} coder of the Alamouti coders encodes an i^{th} symbol vector in the Alamouti scheme and transmits the encoded symbol vector through (2i−1)^{th} and 2i^{th} antennas during (2i−1)^{th} and 2i^{th} time intervals.

16. The transmitter of claim 14, wherein the recombining is performed by grouping the real and imaginary parts by twos.

17. A space-time block coding method in a transmitter having a plurality of transmit antennas, comprising the steps of:
pre-coding an input symbol sequence by multiplying the input symbol sequence by e^{jθ}, θ being a phase rotation angle, in case of QPSK in range of 0≦θ≦90, 23.5≦θ≦24.5, or 65.5≦θ≦66.5, in case of 16QAM in range of 0≦θ≦90, 15.5≦θ≦17.5, or 72.5≦θ≦74.5, into a pre-coded symbol sequence being reconstructed to have real and imaginary parts;
generating symbol vectors by recombining the real and imaginary parts of the pre-coded symbol sequence using an interleaving scheme;
encoding the symbol vectors using an Alamouti scheme; and
transmitting the encoded symbol vectors through corresponding transmit antennas.

18. The space-time block coding method of claim 17, wherein an i^{th} coder of the Alamouti coders encodes an i^{th} symbol vector in the Alamouti scheme and transmits the encoded symbol vector through (2i−1)^{th} and 2i^{th} antennas during (2i−1)^{th} and 2i^{th} time intervals.

19. The space-time block coding method of claim 17, wherein the recombining is performed by grouping the real and imaginary parts by twos.

20. A method of space-time block coding in a transmitter with four transmit antennas, comprising the steps of:
pre-coding an input symbol sequence by multiplying the input symbol sequence by e^{jθ}, θ being a phase rotation angle, in case of QPSK in range of 90<θ, 23.5+90n≦θ≦24.5+90n, or 65.5+90n≦θ≦66.5+90n, in case of 16QAM in range of 90<θ, 15.5n≦0≦17.5n, or 72.5n≦0≦74.5n, where n is an integer, into a pre-coded symbol sequence being reconstructed to have real and imaginary parts;
generating symbol vectors by recombining the real and imaginary parts of the pre-coded symbol sequence using an interleaving scheme;
encoding the symbol vectors using an Alamouti scheme; and
transmitting the encoded symbol vectors through corresponding transmit antennas.

21. The space-time block coding method of claim 20, wherein an i^{th} coder of Alamouti coders encodes an i^{th} symbol vector using the Alamouti scheme and transmits the encoded symbol vector through (2i−1)^{th} and 2i^{th} antennas during (2i−1)^{th} and 2i^{th} time intervals.

22. The space-time block coding method of claim 20, wherein the recombining is performed by grouping the real and imaginary parts by twos.

23. A method of space-time block coding in a transmitter with an even number of transmit antennas, comprising the steps of:
pre-coding an input symbol sequence by multiplying even columns of the input symbol sequence by exp(jθ₁) and multiplying odd columns of the input symbol sequence by exp(jθ₂) according to a predetermined modulation scheme, into a pre-coded symbol sequence being reconstructed to have real and imaginary parts;
generating symbol vectors by recombining the real and imaginary parts of the pre-coded symbol sequence using an interleaving scheme;
encoding the symbol vectors using an Alamouti scheme; and
transmitting the encoded symbol vectors through the transmit antennas.

24. The space-time block coding method of claim 23, wherein an i^{th} Alamouti coder encodes an i^{th} symbol vector using the Alamouti scheme and transmits the encoded symbol vector through (2i−1)^{th} and 2i^{th} antennas during (2i−1)^{th} and 2i^{th} time intervals.

25. The space-time block coding method of claim 23, wherein the recombining is performed by grouping the real and imaginary parts by twos.
